(19) United States
(12) Patent Application Publication
(10) Pub. No.: US 2016/0307283 A1
(43) Pub. Date: Oct. 20, 2016

(54) DOCUMENT GENERATION BASED ON A HIERARCHAL TREE DATASET

(71) Applicants: Roy S. MELZER, Tel-Aviv (IL); Inbal BAUMER, Tel-Aviv (IL)

(72) Inventors: Roy S. MELZER, Tel-Aviv (IL); Inbal BAUMER, Tel-Aviv (IL)

(21) Appl. No.: 15/132,493

(22) Filed: Apr. 19, 2016

Related U.S. Application Data
(60) Provisional application No. 62/149,609, filed on Apr. 19, 2015.

(51) Int. Cl. G06Q 50/18; G06F 17/30

(52) U.S. Cl. CPC G06Q 50/18; G06F 17/30327; G06F 17/30011

(57) ABSTRACT

A method of automatically authoring a document. The method comprises for each of a plurality of lawful aspects of a legal object repeating: accessing a hierarchal tree dataset defining questions as nodes and linking the nodes based on optional answers to each of the questions. Each of a plurality of alternative clauses for a respective lawful aspect of the lawful aspects is mapped to at least one leaf node of the hierarchal tree dataset. The method further comprises repeating the following: identifying a root to leaf path in the hierarchal tree dataset according to answers of a user to at least some of the questions during a question and answer session related to the respective lawful aspect, selecting at least one of the alternative clauses for the respective lawful aspect based on the root to leaf path, and adding the selected alternative clause(s) to an automatically authored document.

### RELATED APPLICATION

This application claims the benefit of priority under 35 USC 119(e) of U.S. Provisional Patent Application No. 62/149,609 filed on Apr. 19, 2015, the contents of which are incorporated herein by reference in their entirety.

### BACKGROUND

The present invention, in some embodiments thereof, relates to automatic document generation and, more specifically, but not exclusively, to automatic document generation based on user inputs and selections.

During the last years various systems have provided processes for generating a tailored contracting document in response to user input data for example where each document is in response to a user input and where the method is carried out in relation to a database having an enhanced arrangement of multi-data field logic tables.

### SUMMARY

According to some embodiments of the present invention, there is provided a method of automatically authoring a document for a legal object. The method comprises for each one of a plurality of lawful aspects of a legal object repeating the following: accessing a hierarchal tree dataset defining a plurality of questions as a plurality of nodes and linking the plurality of nodes based on a plurality of optional answers to each of the plurality of questions, wherein each of a plurality of alternative clauses for a respective lawful aspect of the plurality of lawful aspects is mapped to at least one leaf node of the hierarchal tree dataset, identifying a root to leaf path in the hierarchal tree dataset according to answers of a user to at least some of the plurality of questions during a question and answer session related to the respective lawful aspect, selecting at least one of the plurality of alternative clauses for the respective lawful aspect based on the root to leaf path, adding the at least one selected alternative clause to an automatically authored document, and outputting the automatically authored document.

Optionally, the plurality of optional answers is set as links such that each the optional answer hierarchically links between a certain tier question of the plurality of questions and another tier question of the plurality of questions.

According to some embodiments of the present invention, there is provided a method of automatically authoring a contract for a legal object based on question and answers sessions held with a plurality of parties. The method comprises for each one of a plurality of lawful aspects of a legal object repeating the following, accessing a hierarchal tree dataset defining a plurality of questions as a plurality of nodes and hierarchically linking the plurality of nodes based on a set of plurality of optional answers to each of the plurality of questions, wherein each of a plurality of alternative clauses for a respective lawful aspect of the plurality of lawful aspects is mapped to at least one leaf node of the hierarchal tree dataset, selecting and presenting to a first party on a first client, in each of a plurality of iterations, a plurality of members of the plurality of questions with a respective the set of plurality of optional answers in an order set according to the hierarchal tree dataset, in each the iteration, presenting a user interface to allow the first party to add at least one mark to indicate at least one member of the set of the plurality of optional answers is not optional, creating a truncated version of the hierarchal tree dataset by replacing at least one respective the set of the plurality of optional answers with at least one new set of optional answers which includes only some of the plurality of optional answers based on the least one mark, selecting and presenting to a second party on a second client in the order the plurality of members each with respective the at least one new set of optional answers, selecting at least one of the plurality of alternative clauses for the respective lawful aspect based on answers of the second party to the plurality of members, adding the at least one selected alternative clause to an automatically authored contract, and outputting the automatically authored contract.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart of a method of automatically authoring a document, according to some embodiments of the present invention;

FIG. 2 is a schematic illustration of an exemplary system having one or more servers running a document generation module and managing a database of hierarchal tree forest dataset records and one or more client modules 202, for supporting a method according to some embodiments of the present invention;

FIG. 3 is a schematic illustration of an exemplary hierarchal tree dataset, according to some embodiments of the present invention;

FIG. 4 is an exemplary hierarchal tree forest dataset having a plurality of exemplary hierarchal tree datasets, each having question nodes linked by answer edges and leading in numerous optional paths from the root to any of the leafs where each leaf is associate with a legal clauses related to the legal aspect, according to some embodiments of the present invention;

FIGS. 5A-5D are exemplary screenshots of a GUI presenting questions which are iteratively displayed to a user based on answers he provides, according to some embodiments of the present invention;

FIG. 6 is a system that allows a plurality of users which uses different clients to participate in the authoring of a document by, according to some embodiments of the present invention; and

FIG. 7 is a flowchart of an iterative process for automatically authoring a contract for a legal object based on question and answers sessions held with a plurality of parties, according to some embodiments of the present invention.

### DETAILED DESCRIPTION

The present invention, in some embodiments thereof, relates to automatic document generation and, more specifically, but not exclusively, to automatic document generation based on user inputs and selections.

According to some embodiments of the present invention, there are provided methods and systems of using a hierarchal tree forest dataset for automatically selecting and presenting questions to a user and for routing in the hierarchal tree forest dataset based on answers received from the user. The process allows selecting clauses and/or paragraphs which are adapted to the user's answers and automatically added to a document, such as a legal contract or a report. The methods and systems are based on a graphical user interface that sequentially gathers answers to sequentially presented questions.

According to some embodiments of the present invention, there are provided methods and systems of using a hierarchal tree forest dataset in an iterative negotiation process wherein two or more parties participate in the authoring a contract. In each of some or all of the iterations, one of the parties, optionally interchangeably, deselects optional answers for the other party, leaving him with acceptable options for the next iteration. This allows a user, by approving an answer, to actually conclude an aspect of the negotiation, leaving only points of friction to discuss. Optionally, edges of the hierarchal tree forest dataset represent optional answers and in some or all of the iterations these edges are truncated, forming a more sparse version of the hierarchal tree forest dataset and therefore promotes the negotiation between the parties.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

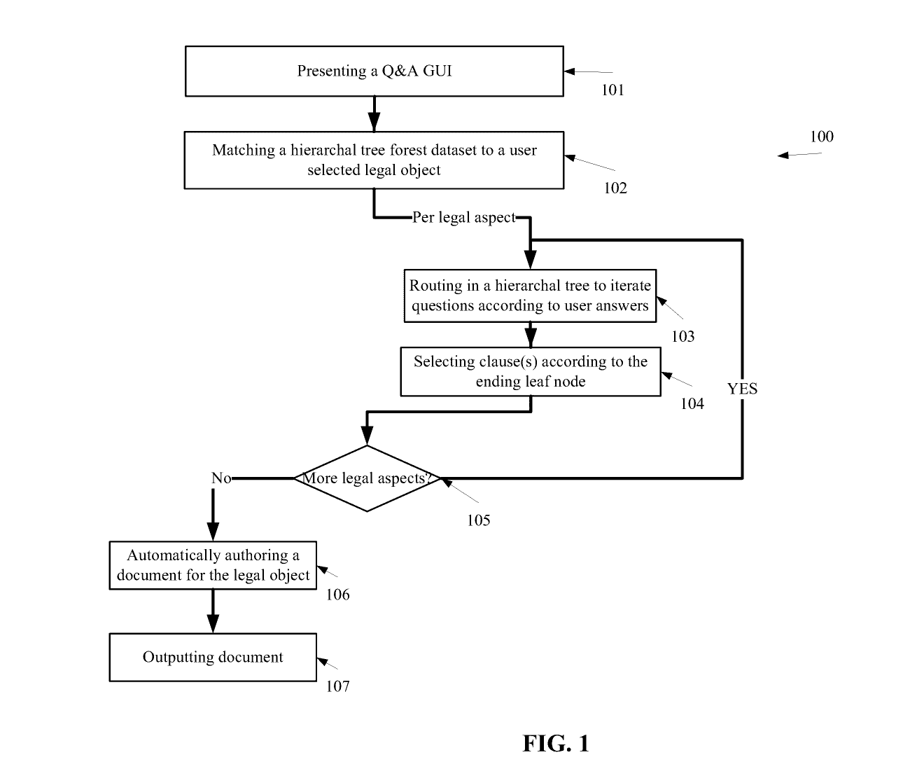

Reference is now made to FIG. 1, which is a flowchart 100 of a method of automatically authoring a document, such as a legal contact, a correspondence, a form such as a legal form, a report such as a medical report and/or the like, for an object, such as a legal object or a commercial object, having a plurality of aspects. Such as legal aspects, by routing, per aspect and based on user inputs, in a hierarchal tree dataset that is linked to a set of optional clauses and optionally clause explanations, such as legal and/or business, according to some embodiments of the present invention. Although the description herein refers to legal objects and aspects other objects and aspects can be covered, for example medical objects with medical aspects, commercial objects with commercial aspects, social objects with social aspects and/or the like. A legal object may be a real-estate rent or purchase event, a commercial agreement, and/or a patent application filing, and/or the like. A legal aspect may be a fact dependent legal arrangement. An exemplary legal aspect may be a legal matter usually covered by one or more clauses, for example securities in a rental agreement, founder responsibilities in founders' agreement, payment distributions in a sale agreement, and/or the like. It should be noted that a clause may be a word, a number, a sentence or one or more paragraphs, a text combining an image, a chart, a table and/or any other visual representations. It should also be noted that a clause may include no visual expressions, i.e. no words, paragraphs etc.

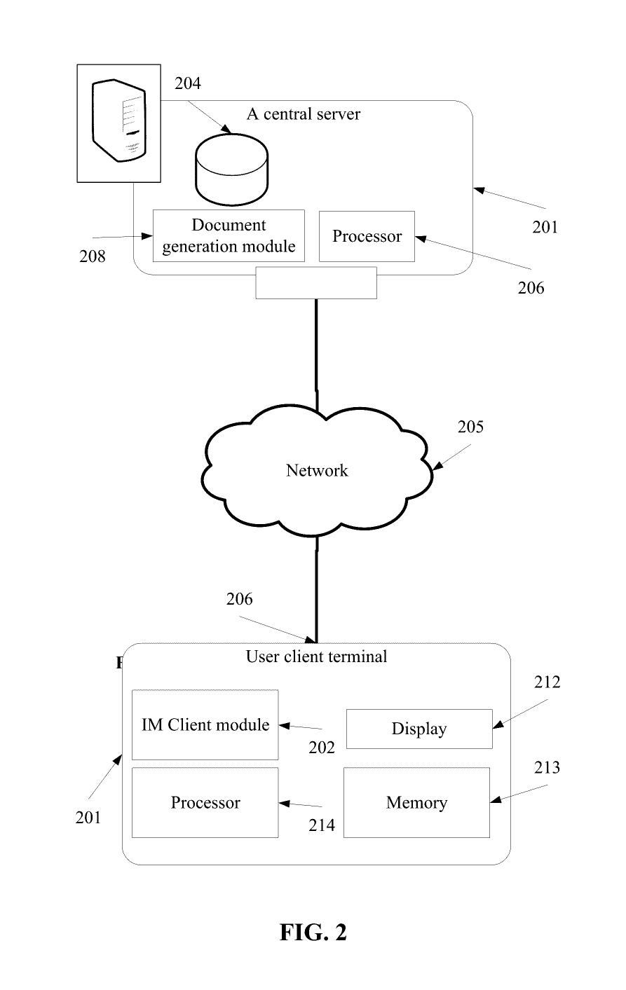

Reference is also made to FIG. 2, which is a schematic illustration of an exemplary system 200 having one or more servers 201 (e.g. web server(s), virtual machine(s), and/or the like) running using a processor 206 a document generation module 208 and managing a database of hierarchal tree forest dataset records 204 and one or more client modules 202, optionally connected to the server 201 via a network 205, for example either locally installed in a client 206 having a presentation unit, a display 212, a processor 214, and a memory 213 or accessible via a browser, for supporting the method 100, according to some embodiments of the present invention.

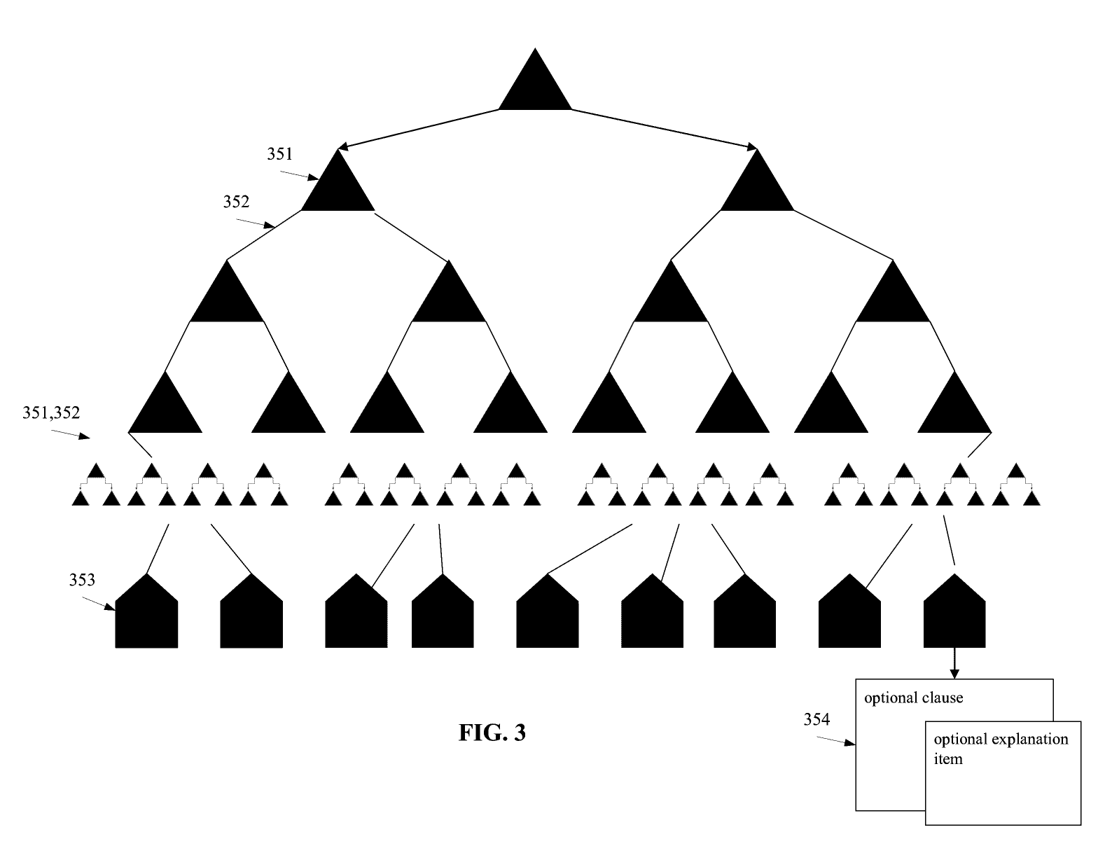

The database of hierarchal tree forest dataset records 204 stores, per each legal object from a plurality of legal objects, one or more hierarchal tree forest dataset(s) 204. A hierarchal tree forest dataset includes a plurality of hierarchal tree datasets, each for another legal aspect. For example, FIG. 3 is a schematic illustration of an exemplary hierarchal tree dataset, according to some embodiments of the present invention. Each node 351 of the hierarchal tree dataset defines one of a plurality of human readable questions which are related to the legal aspect and each of a plurality of edges, for example 352, representing an answer to one of the plurality of human readable questions. The order of the nodes in the hierarchal tree dataset defines a presentation order according to which questions are selected and presented while the user runs a wizard for building a document, optionally a legal document according to some embodiments of the present invention. For example, each central node, namely a tree node which is not a root node or a leaf node, represents a question (e.g. 351) and linked by edges (e.g. 352) to one or more nodes representing parent questions and to one or more nodes representing child questions. For brevity, a node representing a question is referred to as a question node and an edge representing an answer is referred to as an answer node. Some or all of the nodes is associated with one or more optional clauses suitable to cover one or more legal aspects of the legal object.] The hierarchal tree dataset includes a plurality of leaf nodes, each, such as 353, is linked to one or more question nodes. Each one of the leaf nodes of the hierarchal tree dataset is associated with one of a plurality of optional clauses suitable to cover the respective legal aspect. Optionally, some of the leaf nodes are not linked to clauses, for instance when the question logically leads to a lack of need in a clause, no clause is added. This can be marked by a node status identifier and/or by an empty field. Optionally, each clause may be presented with a respective explanation item, for instance based on a single click or selection by a user. In such embodiment, the user may be presented with a sequence of clauses arranged as a document, such as a report or a contract and upon a user selection or deselection as a sequence of clauses intertwined with explanations.

According to some embodiments of the present invention, different hierarchal tree forest dataset records 204 are stored, for each object. In such embodiments, clauses may be adapted to the type of the legal entity, for example a seller, a buyer, a retailer, a consumer, a lender, a bank, and/or the like. In such a manner, clauses are adapted to the type of the legal entity.

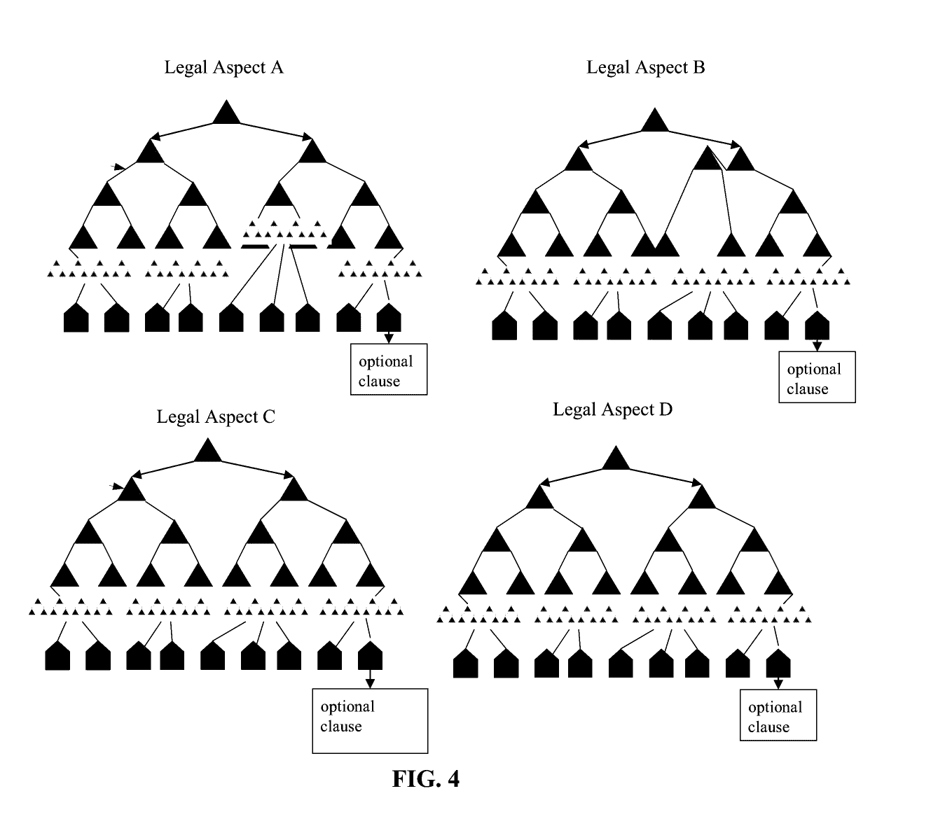

For example, FIG. 4 is an exemplary hierarchal tree forest dataset having a plurality of exemplary hierarchal tree datasets (e.g. A-D) each having question nodes linked by answer edges and leading in numerous optional paths from the root to any of the leafs where each leaf is associate with a legal clauses related to the legal aspect.

Optionally, each question node and/or leaf node (legal clause) is associated with one or more explanation items, for instance paragraphs, media objects such as audio or video files and/or the like. The explanation items can now be presented with the respective questions and/or clauses, for example by the GUI presenting the questions as described below. Optionally, active questions nodes, namely questions nodes according to which questions are presented, are selected from the questions nodes in the tree, forming a hierarchal sub tree dataset that is used for presenting questions to the user. In such embodiments, different questions may be presented to a user of one type, for example a seller, and not to a user of another type, for example a buyer.

In use, as shown at 101, a user is presented with a user interface (UI), for example a graphical user interface (GUI), for example a GUI managed by a server and presented to a user via a browser running on a client terminal, such as a laptop, a tablet, Smartwatch, Smartglasses, a Smartphone and/or the like. The GUI may also be locally managed by a client module, such as locally installed software or a browser add-on.

As shown at 102, the GUI identifies a user selection indicative of a legal object from a plurality of legal objects in the database. A respective hierarchal tree forest dataset record matched to the user selected legal object. Optionally, the hierarchal tree datasets in the hierarchal tree forest dataset record are ordered.

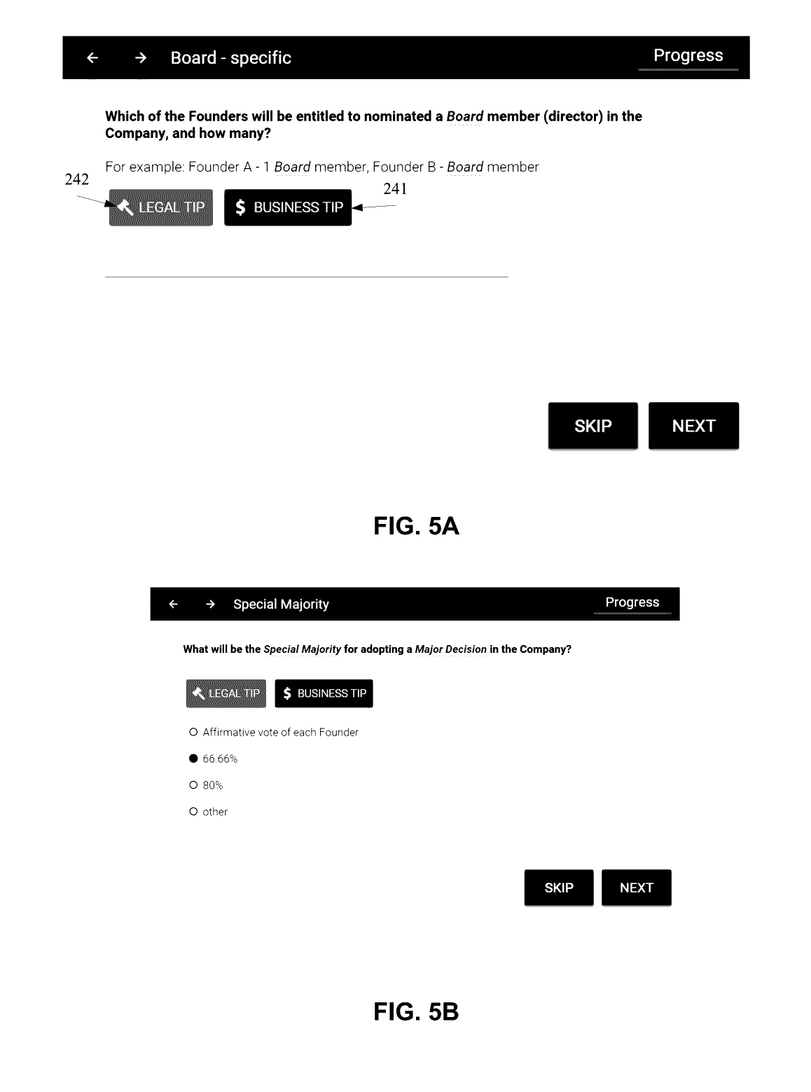

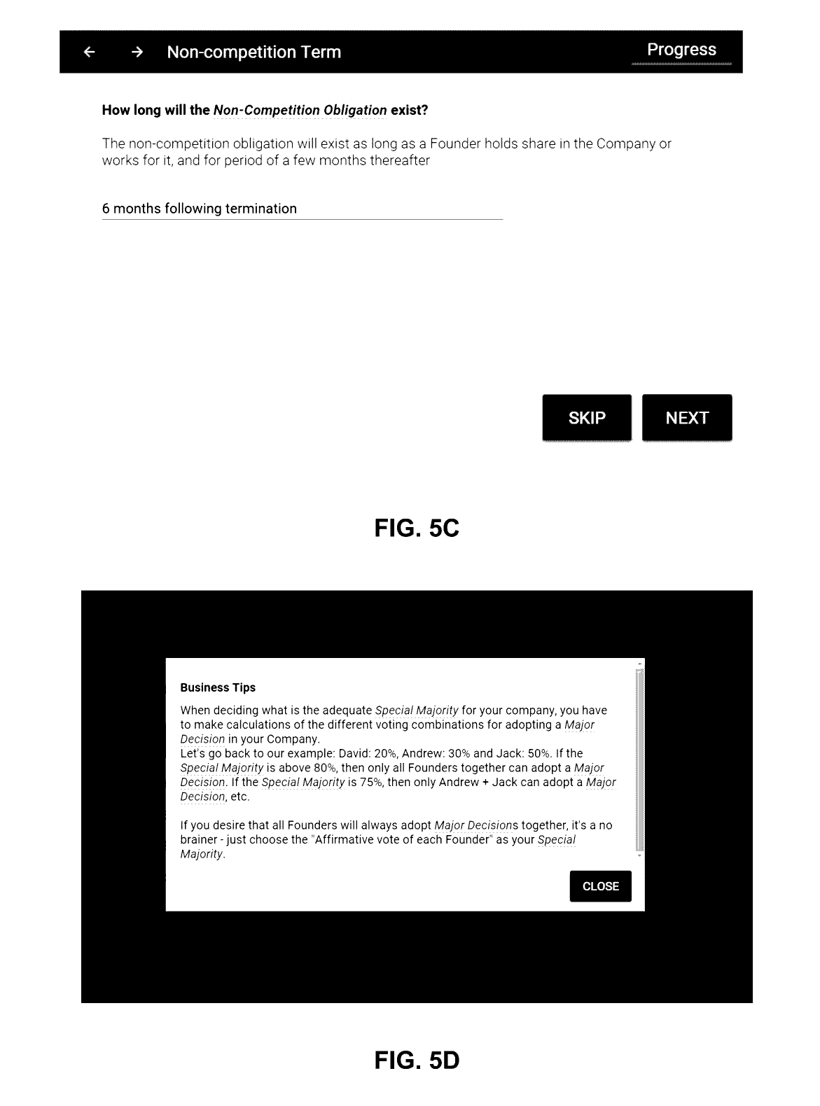

Then, iteratively, as shown at 103, per hierarchal tree dataset in the selected hierarchal tree forest, a set of questions are iteratively selected based on the routing in the hierarchal tree dataset that is triggered by the user answers. In use, questions are sequentially extracted from the hierarchal tree dataset based on the answers inputted by the user where an answer given to a question of a node in tier n in the hierarchal tree dataset is used to select a node from tier n+1 in the hierarchal tree dataset and to present the question which is associated with this node. For example, a user is presented, for example using a GUI of the client 202, with a question associated with a root node of one of the hierarchal tree datasets. For instance, FIGS. 5A-5D are exemplary screenshots of a GUI presenting questions which are iteratively displayed to a user based on answers he provides. Optionally, explanation items which are associated with the answers may be presented, for instance in response to a selection of a button, such as 241, 242. As indicated above, The GUI may present possible answers from answer edges connecting the root node to child nodes. The possible answers may be presented as optional multiple choice test answers. Based on an answer indicative of one of the answer edge, for example a user input indicative of a user selection, the GUI presents, the question represented by the child question. Paths A and B in FIG. 3 are exemplary paths selected according to user answers. This process is repeated until a leaf node is pointed by an answer edge selected according to user input. In this process, user answers build a root to leaf routing path mapping answers of the user and indicating a selected leaf node.

As shown at 104, one or more optional clauses associated with each of the selected leaf node(s) are identified and optionally added or marked to be added to a legal document for the legal object. The selection may be dependent on the routed to leaf node and/or on nodes through which the user routed to the leaf node.

As shown at 105, this process is repeated to all legal aspects such that for each one of the legal aspects a leaf node is selected and one or more respective clauses may be added or marked to be added.

This allows, as shown at 106 and 107, a document is automatically authored by the system 200 and outputted for presentation to the user, for example as a file or a rendered document which includes clauses to cover all or some of the legal aspects of the selected legal object.

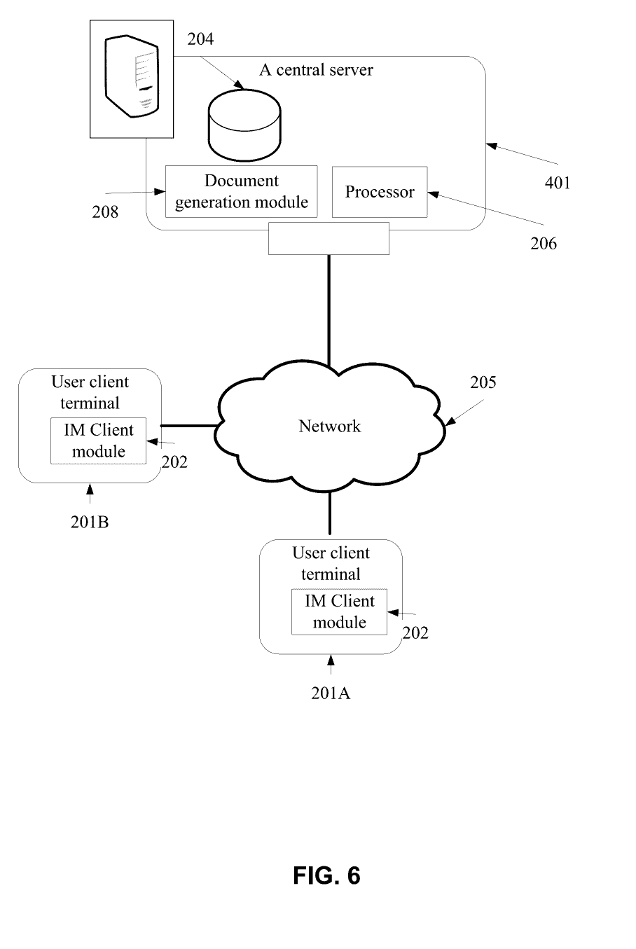

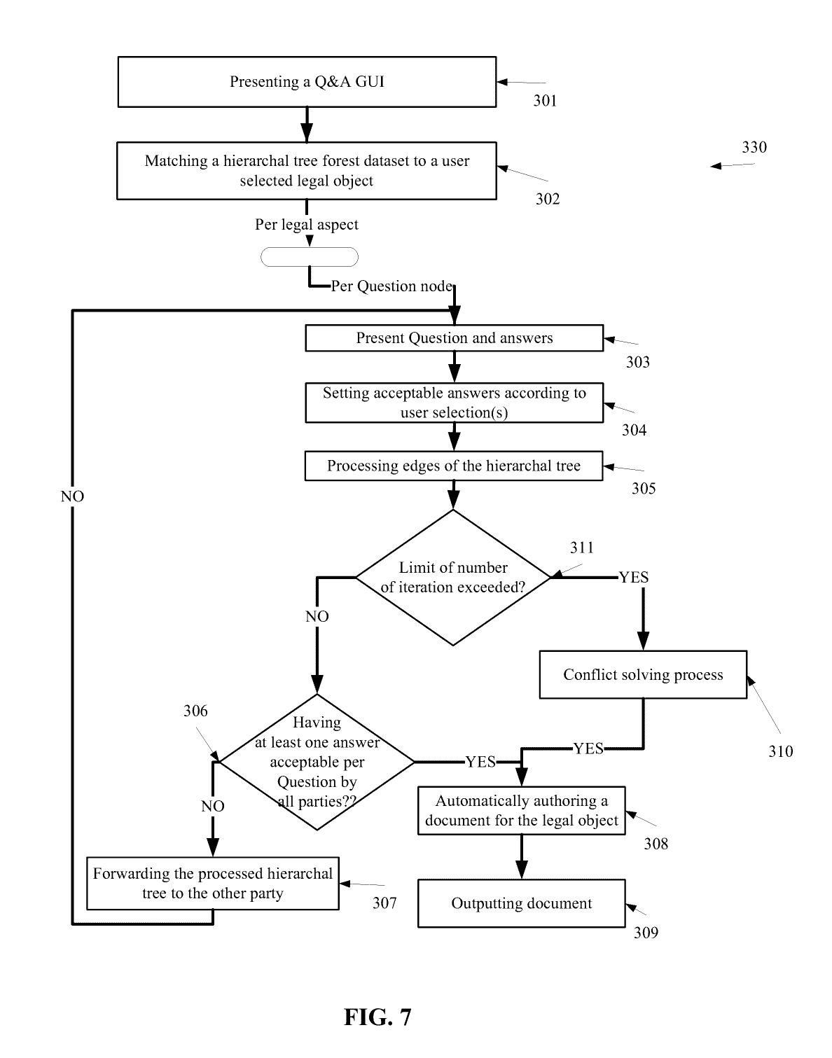

Reference is now made to FIG. 7, which is a flowchart of an iterative process 330 for automatically authoring a contract for a legal object based on question and answers sessions held with a plurality of parties, according to some embodiments of the present invention. The method is optionally based on a system as depicted in FIG. 6 that allows a plurality of users which use different clients 201A-B to participate in the authoring of a document by indicating, per question, which answers are acceptable for him, according to some embodiments of the present invention. The server 401 as 201; however the document generation module 208 is now adapted to truncate hierarchal trees based on user inputs and to manage a multi-participant document generation process, for example as described below.

First, as shown at 301 and 302, a hierarchal tree forest dataset is selected by one or more of the parties. For example the hierarchal tree dataset is selected in response to a selection of a legal object by one of the parties. Optionally, a hierarchal tree forest dataset record containing a version of the hierarchal tree datasets or a link thereto is created and associated with the one or more of the parties.

Now, as shown at 303, per legal aspect (and hierarchal tree) questions defined by nodes of the respective hierarchal tree of the hierarchal tree forest dataset are iteratively presented to one of the parties, referred to herein as the editing party. The presentation is optionally ordered as described with reference to FIG. 1.

Optionally, each question is presented with answers as defined by the edges connecting the question node of the presented question to proceeding question nodes.

Now, per question, as shown at 304, user selections of the editing party are received. These inputs are indicative of one or more of the answers for removal or non-removal. In such a manner, the user actually marks which answers are acceptable answers and which answers are not acceptable for him For example, the editing party may mark or demark a checkbox in proximity to answer(s) he or she would like to remove or not to remove. Optionally, some selected or deselected answers are open answers which allow the party to input a value. In such an embodiment, an entering of an answer value may create a new answer edge that is added to the respective hierarchal tree dataset or fills in a value associated with an existing answer edge. For example, an answer value may be added to an answer to a question requiring a percentage value as an answer (e.g. ownership percentage)m a number of months (e.g. waiting period), and/or a defined payment (e.g. sum of liability). The above allows the entering party to outline borders to what is agreed and/or not agreed on her or his side.

When only one answer edge remains, the party actually indicates that no selection should be available with regard to the legal question at hand. Optionally, in the truncated version, answer selected for removal are marked as such for a following editing party, for example grayed or otherwise marked.

According to the entering party selections or deselections, as shown at 305, answers edges in the hierarchal tree dataset defined by the hierarchal tree dataset record are truncated or marked as truncated, creating a truncated version of the hierarchal tree dataset.

As shown at 306, 303-305 are now repeated for the following editing party, based on the truncated version or the link thereto, allowing the following editing party to further select or deselect one or more of the answers for removal or non-removal.

To allow this iterative process, as shown at 307, the truncated version or a link thereto is optionally forwarded to be used to present questions and acceptable answers to the following editing party. As the truncated version marks which answers are acceptable answers for the editing party, the GUI can now simply outline to the other party which of the possible answers defined in the respective hierarchal tree dataset forest will be acceptable to the other parties and which possible answers may lead to a conflict.

As indicated above, deselected answers may be marked, allowing the editing party to reselect them while deselecting others. It should be noted that the truncated version includes truncated hierarchal tree datasets of various legal aspects.

Optionally, conflicts on acceptable answers are marked during the iterative process. For example, when a first party answers the question of “what is the rent period?” with the answer 12 months and a second party answers the same question with the number 24 months although the period 12 months was indicated as acceptable by the other party, the question is marked with a conflict icon or colored while both answers are marked as conflicting answers.

As shown at 306, this process may be repeated any number of times which are agreed by the parties. For example, when one party selects for each one of the questions an answer which is acceptable to the other party, the iterative process ends and an automated authoring of a document such as a contract is generated, for example as described below. When the answer selection of one editing party to one question is not made from answers selected as acceptable by another editing party, a selection/deselection conflict is identified, for instance by a contract managing submodule of the document generation module 208.

When the selection of answers by the following editing party is made only from the answers selected by the editing party as acceptable answers, the process proceeds to 308. As shown at 308 and similar to 106, a document which includes clauses to cover all legal aspects of the selected legal object can now be automatically authored and outputted, as shown at 309.

Optionally, the number of iterations is limited in advance by the parties, for instance as shown at 311. As 310, when a selection/deselection conflict is identified, the respective question at hand is marked for negotiation and forwarded for a conflict solving process.

Optionally, as shown at 310, a conflict solving submodule of the document generation module 208 generates a report listing the questions marked as selection/deselection conflicts, optionally with the conflict answers at hand. This allows the parties to focus the negotiation on the selection/deselection conflicts while removing issues covered by mutually acceptable answers from the negotiation table. As shown at 311, after agreeing on mutually acceptable answers to the selection/deselection conflicts, the mutually acceptable answers may be marked, promoting the process toward automatically authoring and outputting a document which includes clauses to cover all legal aspects of the selected legal object.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant methods and systems will be developed and the scope of the term a module, a processor, a GUI, and a network is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting or” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of automatically authoring a document for a legal object, comprising:
for each one of a plurality of lawful aspects of a legal object repeating the following:
accessing a hierarchal tree dataset defining a plurality of questions as a plurality of nodes and linking said plurality of nodes based on a plurality of optional answers to each of said plurality of questions;
wherein each of a plurality of alternative clauses for a respective lawful aspect of said plurality of lawful aspects is mapped to at least one leaf node of said hierarchal tree dataset;
identifying a root to leaf path in said hierarchal tree dataset according to answers of a user to at least some of said plurality of questions during a question and answer session related to said respective lawful aspect;
selecting at least one of said plurality of alternative clauses for said respective lawful aspect based on said root to leaf path;
adding said at least one selected alternative clause to an automatically authored document;
outputting said automatically authored document.

2. The method of claim 1, wherein said plurality of optional answers are set as links such that each said optional answer hierarchically links between a certain tier question of said plurality of questions and another tier question of said plurality of questions.

3. A non transitory computer readable medium comprising computer executable instructions adapted to perform the method of claim 1.

4. A method of automatically authoring a contract for a legal object based on question and answers sessions held with a plurality of parties, comprising:
for each one of a plurality of lawful aspects of a legal object repeating the following:
accessing a hierarchal tree dataset defining a plurality of questions as a plurality of nodes and hierarchically linking said plurality of nodes based on a set of plurality of optional answers to each of said plurality of questions;
wherein each of a plurality of alternative clauses for a respective lawful aspect of said plurality of lawful aspects is mapped to at least one leaf node of said hierarchal tree dataset;
selecting and presenting to a first party on a first client, in each of a plurality of iterations, a plurality of members of said plurality of questions with a respective said set of plurality of optional answers in an order set according to said hierarchal tree dataset;
in each said iteration, presenting a user interface to allow said first party to add at least one mark to indicate at least one member of said set of said plurality of optional answers is not optional;
creating a truncated version of said hierarchal tree dataset by replacing at least one respective said set of said plurality of optional answers with at least one new set of optional answers which includes only some of said plurality of optional answers based on said least one mark;
selecting and presenting to a second party on a second client in said order said plurality of members each with respective said at least one new set of optional answers;
selecting at least one of said plurality of alternative clauses for said respective lawful aspect based on answers of said second party to said plurality of members; and
adding said at least one selected alternative clause to an automatically authored contract;
outputting said automatically authored contract.
